(19) United States
(12) Patent Application Publication
(10) Pub. No.: US 2014/0269649 A1
(43) Pub. Date: Sep. 18, 2014

(54) INTEGRATED PERSONAL HOTSPOT AND CAR CHARGING ADAPTER DEVICE

(71) Applicant: Novatel Wireless, Inc., (US)

(72) Inventor: Ian Lockerbie, Calgary (CA)

(21) Appl. No.: 13/830,414

(22) Filed: Mar. 14, 2013

(51) Int. Cl. H04W 76/02

(52) U.S. Cl. CPC H04W 76/02
USPC 370/338

(57) ABSTRACT

A personal hotspot and charging adapter device is provided that integrates aspects of a personal hotspot device and a charging adapter device, such as that which can be utilized in conjunction with a power jack, e.g., a cigarette lighter receptacle within a vehicle or similar power supply. Such a personal hotspot and charging adapter device is capable of providing connectivity between a host computing device and a data network, such as the Internet, via, e.g., a wireless local area network (WLAN) connection between the host computing device and the personal hotspot and charging adapter device, and a wireless wide area network (WWAN) connection between the personal hotspot and charging adapter device and service provider, where the personal hotspot aspect of the personal hotspot and charging adapter device may be powered without a need for extra cabling or inconvenient installation in the vehicle.

### TECHNICAL FIELD

The present application relates generally to portable communications devices, and more particularly, to an integrated personal hotspot and charging adapter device.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various electronic devices, such as compact disc (CD) players, portable communications devices (e.g., portable phones), digital audio players and/or frequency modulation (FM) transmitters for such digital audio players, beverage heating devices, fans, etc. can often be configured to be powered/operated via a battery power supply, as well as through some type of alternating current (AC)/direct current (DC) power outlet. Given the shift to a more mobile lifestyle, users often leverage the ability to use a power jack/outlet, e.g., a cigarette lighter receptacle, often found in vehicles to power such electronic devices. For example, a portable phone may be connected to a power jack using a car charger adapter/inverter to allow a user to operate a portable phone without draining the battery power supply and/or simultaneously charge the battery power supply.

FIG. 1 illustrates a conventional system 100 that can include an electronic device 102 that may be powered via a power jack of a vehicle, e.g., a cigarette lighter receptacle, for use in the vehicle. A cable 104, having a car charger adapter 106 at one end, may be attached to the electronic device 102, while the car charger adapter 106 may be plugged into a power jack.

However, systems like the conventional system 100 illustrated in FIG. 1 can result in “unwieldy” configurations, where extra cabling may be required to effect the requisite connections between the power jack and electronic device. The use of such extra cabling can often result in the electronic device becoming tangled with other components/devices in the confines of a vehicle, or even elements of the vehicle itself, such as a gear stick. Further still, there is often a lack of space or area(s) in which such electronic devices may be stored, resulting in a cluttered vehicle cabin.

### SUMMARY

Various aspects of examples of the invention are set out in the claims. According to a first aspect, an apparatus comprises a power converter circuit, at least one processor, and at least one memory including computer program code. The memory and the computer program code are configured with the at least one processor to cause the apparatus to establish, utilizing a first radio module, a first wireless connection to a base station associated with a wide area network (WAN); establish, utilizing a second radio module, a second wireless connection with at least one host computing device for a wireless local area network (WLAN); and provide at least one host computing device access to a data network via the WAN. Additionally, the apparatus is configured such that the power converter circuit, the processor, and the memory are contained with a housing having a first end and a second end, the first end being configured to be coupled with a power source for powering at least one of the power converter circuit, the processor, and the memory.

According to a second aspect, a system comprises at least one host computing device, a base station associated with a first wireless communications network, and a personal hotspot device. The personal hotspot device comprises a power converter circuit and a processor. A memory unit is coupled to the processor and includes computer code for establishing, utilizing a first radio module, a first wireless connection to a base station associated with a wide area network (WAN); establishing, utilizing a second radio module, a second wireless connection with at least one host computing device for a wireless local area network (WLAN); providing the at least one host computing device access to a data network via the WAN; and terminating the first wireless connection and the second wireless connection when an ignition system of a vehicle to which the personal hotspot device is operatively connected is turned off. Additionally, the personal hotspot device is encapsulated within a housing, the housing being configured to effectuate power delivery to the personal hotspot device via a power supply to which the housing connects.

### BRIEF DESCRIPTION OF THE DRAWINGS

For a more complete understanding of example embodiments, reference is now made to the following descriptions taken in connection with the accompanying drawings in which:

FIG. 1 illustrates a conventional system for connecting a personal hotspot device to a power source;

FIG. 2 is a perspective view of a personal hotspot and charging adapter device in accordance with various embodiments;

FIG. 3 is a schematic representation of a system architecture in which the personal hotspot and charging adapter device of FIG. 2 may be implemented; and

FIG. 4 is a flow chart illustrating an example process for reducing the drain on a battery utilizing the personal hotspot and charging adapter device of FIG. 2.

### DETAILED DESCRIPTION OF THE DRAWINGS

Example embodiments and their potential advantages are understood by referring to FIGS. 2-4 of the drawings.

A mobile router or portable/personal hotspot device can be utilized to allow network access to one or more user/host computing devices. In this regard, a personal hotspot device can provide connectivity to the host computing devices through a wireless local area network (WLAN) protocol, such as Institute for Electrical and Electronic Engineers (IEEE) 802.11 or WiFi protocols. Host computing devices may include, but are not limited to, for example, laptops, desktop computers, portable phones, personal digital assistants (PDAs), smart phones, or any other device capable of wireless communication. It should be noted that a personal hotspot device can be configured to support a variety of host computing devices, such as those previously described, where the number of host computing devices which can be supported by the personal hotspot device may vary and may be determined by software, firmware or the like within the personal hotspot device.

A personal hotspot device can be configured to communicate with a service provider through, for example, a cellular base station associated with a wireless communication network, such as a wireless wide area network (WWAN), e.g., Third Generation (3G) or Fourth Generation (4G)/Long Term Evolution (LTE) network. Through such a wireless communication network, access to a communication network such as the Internet, or other data network may be provided. Any of a number of servers may also be accessed by a host computing device through the personal hotspot device and the communication network.

As described previously, electronic devices can be configured to operate via battery power and/or via connection to a power outlet, such as a power jack of a vehicle. Being an electronic device, a personal hotspot device can be configured to operate similarly, and like the aforementioned electronic devices, the personal hotspot device can suffer from the limitations of conventional configurations that rely on some type of wired connection to a separate power adapter/inverter for power.

Accordingly, various embodiments of the present disclosure are directed to an integrated personal hotspot and charging adapter device that can be used to interface one or more host computing devices or local area network (LAN) client devices with a WWAN. As alluded to above, and for example, the WWAN can be configured to implement one of the 3G protocols, such as EDGE, CDMA2000, or the Universal Mobile Telecommunications System (UMTS) protocols, High Speed Packet Access (HSPA) or HSPA+ protocols, 4G/LTE protocols, Evolution Data Optimization (EV-DO) rev. A (DOrA), WiMAX, or other 4G protocols. One or more host computing devices may interface with the personal hotspot device and charging adapted device over, e.g., a WLAN, such as a WiFi network, wireless USB network, ultra wideband network, or a Zigbee network. It should be noted that the descriptions and embodiments provided herein are not intended to limit the various embodiments to particular standards or architectures. Rather, the embodiments are being provided by way of example only.

FIG. 2 is a perspective view of an example personal hotspot and charging adapter device 200 that may include a housing 210, that can have a first end 212 and a second end 214. The first end 212 may be sized and dimensioned to be received in a power jack or outlet (such as that in, e.g., a vehicle) and may further include electrical contacts 216 and 218. The electrical contacts 216 and 218 may be configured to receive power from, e.g., a vehicle battery and transfer it to a power converter circuit, as will be described in greater detail below.

The second end 214 of the housing 210 may optionally include one or more mechanisms for interfacing with the personal hotspot and charging adapter device 200, such as a universal serial bus (USB) port 220, a light source 222, etc. That is, a USB plug connected to a host computing device, or other computing device, may be inserted into the USB port 220 for configuring/provisioning the personal hotspot and charging adapter device 200, downloading/uploading data, etc. The light source 222 may be a light emitting diode (LED) that can be configured to illuminate when the personal hotspot and charging adapter device 200 is connected to a power jack or when the personal hotspot and charging adapter device 200 is active as a personal hotspot, to signify charging/powered status, etc.

It should be noted that the aforementioned mechanisms need not be limited to USB and/or lighting interfaces, but may include, e.g., parallel ports, IrDa ports, low voltage serial interfaces, or other standard or proprietary interfaces. Additionally, the location of such interfaces need not be limited to the second end 214 of the housing 210, but may be implemented in any desired area of the housing 210. Further still, the personal hotspot and charging adapter device 200 may be configured to have more or less electrical contacts as needed for interfacing with one or more power supply sources, and may also be configured for “direct powering” rather than or in addition to charging.

FIG. 3 illustrates an example system architecture 300 within which the personal hotspot and charging adapter device 300 can be implemented, where the personal hotspot and charging adapter device 300 may be an embodiment of the personal hotspot and charging adapter device 200 illustrated in FIG. 2. As illustrated in FIG. 3, interior of the personal hotspot and charging adapter device 300 can include a power converter circuit 324, a WAN radio 326, a LAN radio 328, a controller/processor 330, and a memory unit 332.

The power converter circuit 324 may receive power from a power source, such as the aforementioned vehicle battery through electrical contacts (216 and 218 illustrated in FIG. 2), and step down the voltage for use within the personal hotspot and charging adapter device 300. Although a standard car battery can generally supply 12 volts, the personal hotspot and charging adapter 300 may only require 3-4 volts for operation. Accordingly, one type of power converter circuit 324 that can be used for stepping down the voltage is a switch mode power circuit for efficiently providing a regulated output voltage. The power converter circuit 324 may also include thermal, short circuit, and overload protection capabilities.

The WAN radio 326 can be configured to allow the personal hotspot and charging adapter device 300 to access a WAN by communicating with a base station 350 associated with the WAN through wireless signals 352 transmitted and received via antenna 354. Wireless signals 352 can be any signals be appropriate for the communication protocol(s) associated with the WAN radio 326.

The LAN radio 328 allows the personal hotspot and charging adapter device 300 to wirelessly communicate/interact with one or more host computing devices, such as host computing device 360 by exchanging wireless signals 362 (e.g., Transmission Control Protocol (TCP)/Internet Protocol (IP) over WiFi) with the host computing device 360 via antenna 364. Wireless signals 352 and 362 may be the same or different according to the relevant communication protocol(s) utilized by the WAN and LAN/WAN radio 326 and LAN radio 328.

When the personal hotspot and charging adapter device 300 is connected to the power jack of a vehicle in operation, a connection with the base station 350 can be established and WAN connectivity may be activated. The personal hotspot and charging adapter device 300 may then be able to route data to/from the one or more host computing device(s) 360 to the WAN associated with the base station 350. In particular, the personal hotspot and charging adapter device 300 may be capable of automatically establishing a data connection, e.g., a Point-to-Point Protocol (PPP) connection, with the base station 350. Thereafter, or substantially simultaneously, the personal hotspot and charging adapter device 300 may enable LAN connectivity, thus acting as a wireless LAN access point.

The one or more host computing device(s) 360 may then access provided services, such as, e.g., Internet access, by way of the personal hotspot and charging adapter device 300. It should be noted that certain authentication/authorization procedures may be executed before allowing Internet (or other service) access. A user may complete such authentication/authorization procedures via the host computing device 360, or through various mechanisms provided by or between the host computing device 260 and the personal hotspot and charging adapter device 300.

It may also be possible for the LAN radio 328 to establish connectivity with another network, e.g. a public LAN or a home or business LAN, via the base station 350. In this case, the personal hotspot and charging adapter device 300 can maintain connectivity with host computing devices and seamlessly hand data over to a non-WAN carrier (e.g., the public LAN, home LAN, or business LAN). This allows for the personal hotspot and charging adapter device 300 to use a lower cost transport to the Internet without impacting the operation of a host computing device. In this case, there is a possibility of using the same LAN or using some other transport.

The controller/processor 330 may include one or more processing cores such as a digital signal processing core, a micro-processing core, math-coprocessors, etc. The memory unit 332 may comprise one or more types of memory, including but not limited to volatile memory (for storing “transient” data) as well as non-volatile memory (for storing, e.g., computer program code for running/operating the controller/processor 330) memory. Examples of volatile memory include, but are not limited to, Dynamic Random Access Memory (DRAM) and static random access memory (SRAM). Examples of non-volatile memory include, but are not limited to, Programmable ROM (PROM), Erasable PROMs (EPROM), Electrically erasable PROM (EEPROM), Flash memory, or some combination thereof. In certain embodiments, some portion or even all of non-volatile memory, volatile memory, or both can be included with the controller/processor 330.

It should be noted that recently, more and more electronic devices have incorporated the use of some type of flash memory to, e.g., expand the native memory of such electronic devices. For example, personal hotspot devices can utilize flash memory in the form of memory cards such as, e.g., Secure Digital (SD) cards, that may be insertable and removable by a user. Uses for such SD cards include storing multimedia content such as music and picture files, contact information, etc., which allows users of such personal hotspot devices that may be connected to a host computing device, e.g., a laptop computer, via, e.g., a USB connection, to utilize a single/integrated device for communication purposes as well as for external storage, or even additional functionality implemented in the SD card.

Accordingly, users may often wish to access the memory in a personal hotspot device. Thus, various embodiments of the present disclosure, as alluded to above, and as will be discussed in greater detail below, allow a user to easily access the memory unit 332, e.g., an SD card) while the personal hotspot and charging adapter device 300 is connected to a power jack of a vehicle. Although a personal hotspot device may be installed in a vehicle, doing so may result in, e.g., a user not being able to access the SD card. Hence, configurations in accordance with various embodiments, such as those described herein allow for easy access to memory, while still having a “neat”/uncluttered implementation of the personal hotspot and charging adapter device 300.

The controller/processor 330 may further serve as a processing backend for both of the WAN radio 326 and the LAN radio 328. Alternatively, separate processing circuitry (not shown) may be included for each of the LAN functionality and the WAN functionality, such that LAN/WAN radio modules/circuitry can be integrated into/as part of the controller/processor 330. Instructions stored in the memory unit 332 may be used by the controller/processor 330 to control the operation of the personal hotspot and charging adapter device 300, which can include operation of the WAN radio 326 and the LAN radio 328, as well as for bridging communications between the base station 350 and the one or more host computing device(s) 360, and configuring the personal hotspot and charging adapter device 300.

For instance, the memory unit 332 may contain instructions for a process to reduce the drain on a vehicle battery from the personal hotspot and charging adapter device 300, as illustrated in the flowchart of FIG. 4. The process 400 may begin when the power converter circuit 324 receives power from the vehicle battery through the electrical contacts 216 and 218 (400). An on-board diagnostic system of the vehicle may then be queried to determine the status of the ignition (402). If the ignition status suggests that the ignition of the vehicle is “ON,” the personal hotspot and charging adapter device 300 can establish a WAN connection between the personal hotspot and charging adapter device 300 and a WAN base station 350 (406), and a LAN connection between the personal hotspot and charging adapter device 300 and at least one host computing device 360 (408). While the WAN and LAN connections are operating, the process 400 can constantly query the aforementioned on-board diagnostic system to determine whether the ignition is still operating (402). When the ignition status suggests that the ignition is “OFF,” the process 400 may terminate the WAN connection (410). Additionally, the LAN connection may also be terminated (412), thereby shutting down the personal hotspot capabilities of the personal hotspot and charging adapter device 300. In cases where the ignition is never turned “ON,” the process 400 need not establish either the WAN connection or the LAN connection with the personal hotspot and charging adapter device 300. The process 400 may further be configured so that the personal hotspot capabilities of the personal hotspot and charging adapter device 300 terminate as soon as the ignition is turned off or when the ignition has been off for an extended period of time. Thus, another advantage of the process 400 is realized by reducing the amount of data transfer between the personal hotspot and charging adapter device 300 and, e.g., the base station 350. It should be noted that personal hotspot and charging adapter device 300 may be battery-powered and/or capable of being operated directly via a power supply, such as the vehicle battery allowing, for, e.g., seamless operation between transitioning from a home environment to a vehicle environment, for example.

Returning to FIG. 3, and further still, the memory unit 332 may be configured with instructions for operating the LED circuit 334. For instance, the memory unit 332 may direct the LED circuit 334 to illuminate an LED (e.g., LED 222 of FIG. 2) when the personal hotspot and charging adapter device 300 is connected to a power jack, operating as a personal hotspot, etc.

The personal hotspot and charging adapter device 300 may also include a USB interface 336 and a fan 338. The USB interface 336 may include any components needed to connect a USB plug to the device personal hotspot and charging adapter device 300 for interaction with, e.g., the host computing device 360, as previously alluded to. The fan 338 may be used to cool/dissipate heat from the electronics/circuitry/components within the personal hotspot and charging adapter device 300 because vehicles can quickly become warm, causing the electronics/circuitry/components to overheat, or from heat generated by the personal hotspot and charging adapter device 300 itself.

It should be noted that FIG. 3 illustrates various components, elements, and/or modules that may comprise a personal hotspot and charging adapter device 300 in accordance with one or more embodiments. However, it should be understood that more or less components, elements, and/or modules can be included. That is, the embodiment illustrated in FIG. 3 is not intended to exhaustively show all components, but rather is provided by way of example to illustrate certain components in relation to the systems and methods described herein. Moreover, such components, elements, and/or modules may be implemented via multiple components such as multiple integrated circuits, discrete device, or both, and can be packaged in a single package or in multiple packages.

Various embodiments of the present invention may be implemented in a system having multiple host computing devices and/or personal hotspot devices, such as a personal hotspot and charging adapter device configured in accordance with various embodiments that can communicate through one or more networks. The system may comprise any combination of wired or wireless networks such as a mobile telephone network, a WLAN, a Bluetooth personal area network, an Ethernet LAN, a WAN, the Internet, etc. It should be noted that such personal hotspot and charging adapter devices may be utilized, not only in vehicles, but in any other situation/location/environment where it might be advantageous to utilize an apparatus having the aforementioned integrate personal hotspot and charging adapter configuration/capabilities. Additionally, and although various embodiments have been described herein within the context of utilizing a vehicle power jack, various embodiments may be adapted to operate using other types of power sources.

As discussed above, various embodiments contemplate communication capabilities over a variety of transmission/communication technologies and/or protocols, including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), TCP/IP, Short Messaging Service (SMS), Multimedia Messaging Service (MMS), e-mail, Instant Messaging Service (IMS), Bluetooth, IEEE 802.11, Evolution-Data Optimized/Only (EVDO), Worldwide Interoperability for Microwave Access (WiMAX), etc.

In addition to the components/elements described above, an electronic device in accordance with various embodiments may further include a display, a keypad for input, a microphone, an ear-piece, a battery, and one or more antennas. The device may further include radio interface circuitry, codec circuitry, a controller/CPU/processor and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present disclosure to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the various embodiments and with various modifications as are suited to the particular use contemplated. The features of the embodiments described herein may be combined in all possible combinations of methods, apparatus, modules, systems, and computer program products.

If desired, the different functions discussed herein may be performed in a different order and/or concurrently with each other. Furthermore, if desired, one or more of the above-described functions may be optional or may be combined.

Although various aspects of the present disclosure are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the present disclosure, these descriptions should not be viewed in a limiting sense. Rather, there are several variations and modifications which may be made without departing from the scope of the present disclosure as defined in the appended claims.

1. An apparatus comprising:
a power converter circuit;
at least one processor; and
at least one memory including computer program code, the at least one memory and the computer program code configured to, with the at least one processor, cause the apparatus to perform at least the following:
establish, utilizing a first radio module, a first wireless connection to a base station associated with a wide area network (WAN);
establish, utilizing a second radio module, a second wireless connection with at least one host computing device to establish a wireless local area network (WLAN) between the at least one host computing device and the apparatus; and
provide the at least one host computing device access to a data network via the WAN, wherein
the power converter circuit, the processor, and the memory are contained with a housing having a first end and a second end, the first end being configured to be coupled with a power source for powering at least one of the power converter circuit, the processor, and the memory.

2. The apparatus of claim 1, wherein the power converter circuit is a switch mode power supply circuit.

3. The apparatus of claim 1, wherein the WAN comprises a cellular network.

4. The apparatus of claim 1, wherein the WLAN comprises a WiFi network.

5. The apparatus of claim 1, wherein the data network comprises the Internet.

6. The apparatus of claim 1, wherein the housing further comprises a light emitting diode.

7. The apparatus of claim 1, wherein the second end of the housing further comprises a user-accessible data interface.

8. The apparatus of claim 7, wherein the user-accessible data interface comprises a universal serial bus (USB) port.

9. The apparatus of claim 1, wherein the coupling with the power source comprises inserting the apparatus into a car power adaptor.

10. A system comprising:
at least one host computing device;
a base station associated with a first wireless communications network; and
a personal hotspot device for comprising:
a power converter circuit;
a processor; and
a memory unit coupled to the processor and including:
computer code for establishing, utilizing a first radio module, a first wireless connection to the base station associated with the first wireless communications network;
computer code for establishing, utilizing a second radio module, a second wireless connection with the at least one host computing device to establish a wireless local area network (WLAN) between the at least one host computing device and the personal hotspot device;
computer code for providing the at least one host computing device access to a data network via the WLAN; and
computer code for terminating the first wireless connection and the second wireless connection when an ignition system of a vehicle to which the personal hotspot device is operatively connected, is turned off; wherein,
the personal hotspot device is encapsulated within a housing, the housing being configured to effectuate power delivery to the personal hotspot device via a power supply to which the housing connects.

11. The system of claim 10, wherein the power converter circuit comprises a switch mode power supply circuit.

12. The system of claim 10, wherein the WAN comprises a cellular network.

13. The system of claim 10, wherein the WLAN comprises a WiFi network.

14. The system of claim 10, wherein the data network comprises the Internet.

15. The system of claim 10, wherein the housing further comprises at least one electrical contact to for interfacing with the power supply.

16. The system of claim 10, wherein the housing further comprises a user-accessible data interface.

17. The system of claim 16, wherein the user-accessible data interface comprises a universal serial bus (USB) port.

18. The system of claim 10, wherein the memory unit comprises a removable flash memory unit.

19. The system of claim 10, wherein the power supply comprises a cigarette lighter receptacle of the vehicle.

20. The system of claim 10, wherein the power supply comprises a car power adaptor into which the personal hotspot device encapsulated within the housing is inserted.

21. A system comprising:
at least one host computing device;
a base station; and
a personal hotspot device for comprising:
a power converter circuit;
a processor; and
a memory unit coupled to the processor and including:
computer code for establishing, utilizing a first radio module, a first wireless connection to the base station;
computer code for:
establishing, utilizing a second radio module, a second wireless connection with the at least one host computing device to establish a first wireless local area network (WLAN) between the at least one host computing device and the personal hotspot device; and
establishing, utilizing the second radio module, a third wireless connection with a second WLAN to access the base station if the second WLAN is available;
computer code for providing the at least one host computing device access to a data network via one of the first and second WLANs, or via the WLAN and a wireless wide area network (WWAN) associated with the base; and
computer code for terminating the first wireless connection and the second wireless connection when an ignition system of a vehicle to which the personal hotspot device is operatively connected, is turned off; wherein,
the personal hotspot device is encapsulated within a housing, the housing being configured to effectuate power delivery to the personal hotspot device via a power supply to which the housing connects.

22. The system of claim 21, wherein the second WLAN comprises one of a public local area network (LAN), a home LAN, or a business LAN.
